(19) United States
(12) Patent Application Publication
(10) Pub. No.: US 2013/0268261 A1
(43) Pub. Date: Oct. 10, 2013

(54) SEMANTIC ENRICHMENT BY EXPLOITING TOP-K PROCESSING

(71) Applicants: Jong Wook Kim, Torrance, CA (US); Ashwin S. Kashyap, Mountain View, CA (US); Dekai Li, Lawrenceville, GA (US); Sandilya Bhamidipati, Mountain View, CA (US); Avinash Sridhar, Pennington, NJ (US); Saurabh Mathur, Monmouth Junction, NJ (US); Bankim A. Patel, Hillsborough, NJ (US)

(72) Inventors: Jong Wook Kim, Torrance, CA (US); Ashwin S. Kashyap, Mountain View, CA (US); Dekai Li, Lawrenceville, GA (US); Sandilya Bhamidipati, Mountain View, CA (US); Avinash Sridhar, Pennington, NJ (US); Saurabh Mathur, Monmouth Junction, NJ (US); Bankim A. Patel, Hillsborough, NJ (US)

(73) Assignee: THOMSON LICENSING, Issy de Moulineaux (FR)

(21) Appl. No.: 13/701,347

(22) PCT Filed: Jun. 3, 2011
(86) PCT No.: PCT/US11/38991

§ 371 Date: May 20, 2013

Related U.S. Application Data
(60) Provisional application No. 61/351,252, filed on Jun. 3, 2010.
(60) Provisional application No. 61/397,780, filed on Jun. 17, 2010.
(60) Provisional application No. 61/456,774, filed on Nov. 13, 2010.

(51) Int. Cl. G06F 17/27

(52) U.S. Cl. CPC G06F 17/2785
USPC 704/9

(57) ABSTRACT

Proper representation of the meaning of texts is crucial to enhancing many data mining and information retrieval tasks, including clustering, computing semantic relatedness between texts, and searching. Representing of texts in the concept-space derived from Wikipedia has received growing attention recently, due to its comprehensiveness and expertise. This concept-based representation is capable of extracting semantic relatedness between texts that cannot be deduced with the bag of words model. A key obstacle, however, for using Wikipedia as a semantic interpreter is that the sheer size of the concepts derived from Wikipedia makes it hard to efficiently map texts into concept-space. An efficient algorithm is proved which is able to represent the meaning of a text by using the concepts that best match it. In particular, this approach first computes the approximate top- concepts that are most relevant to the given text. These concepts are then leverage to represent the meaning of the given text.

### CROSS REFERENCE TO RELATED APPLICATIONS

This application claims the benefit of U.S. Provisional Application Ser. No. 61/351,252 filed Jun. 3, 2010, U.S. Provisional Application Ser. No. 61/397,780 filed Jun. 15, 2010, and U.S. Provisional Application Ser. No. 61/456,774 filed Nov. 12, 2010 which are incorporated by reference herein in their entirety.

### TECHNICAL FIELD

The present invention relates to data mining and information retrieval and more specifically semantic interpretation of keywords used data mining and information retrieval.

### BACKGROUND

The bag of words (BOW) model has been shown to be very effective in diverse areas which span a large spectrum from traditional text-based applications to web and social media. While there have been a number of models in information retrieval systems using the bag of words, including boolean, probability and fuzzy ones, the word-based vector model is the most commonly used in the literature. In the word-based vector model, given a dictionary, U, with u distinct words, a document is represented as u-dimensional vector \vec{d}, where only those positions in the vector that correspond to the document words are set to >0 and all others are set to 0, which results in a collection of the extremely sparse vectors in a high dimension space.

Although the BOW-based vector model is the most popular scheme, it has limitations: these include sparsity of vectors and lacking semantic relationship between words. One way to overcome these limitations is to analyze the keywords of the documents in the corpus to extract latent concepts that are dominant in the corpus, and models documents in the resulting latent concept-space. While these techniques have produced impressive results in text-based application domains, they still have a limitation in that the resulting latent concepts are different from human-organized knowledge, and thus they cannot be interpreted by human knowledge.

A possible solution to resolve this difficulty is to enrich the individual documents with the background knowledge obtained from existing human-contributed knowledge databases; i.e., Wikipedia, WordNet, and Open Directory Project. For example, Wikipedia is one of the largest free encyclopedias on the Web, containing more than 4 million articles in the English version. Each article in Wikipedia describes a concept (topic), and each concept belongs to at least one category. Wikipedia uses redirect pages, which redirects a concept to another concept, for synonymous ones. On the other hand, if a concept is polysemous, Wikipedia displays possible meanings of polysemous concepts in disambiguation pages.

Due to its comprehensiveness and expertise, Wikipedia has been applied to diverse applications, such as clustering, classification, word disambiguation, user profile creation, link analysis, and topic detection, where it is used as a semantic interpreter which re-interprets (or enriches) original documents based on the concepts of Wikipedia. As shown in FIG. 5, such semantic re-interpretation 500 equals or corresponds to a mapping of original documents from the keyword-space 510 into the concept-space 520. Generally, the mapping between the original dictionary and the concept is performed by (a) matching concepts to keywords and (b) replacing the keywords with these matched concepts. In the literature, this process is commonly defined as the matrix multiplication between the original keyword matrix and the keyword-concept matrix (FIG. 5). Such a Wikipeda-based semantic re-interpretation has the potential to ensure that keywords mapped into the Wikipedia concept-space are semantically informed, significantly improving the effectiveness on various tasks, including text categorization and clustering.

The main obstacle in leveraging a source such as the Wikipedia as a semantic interpreter stems from efficiency concerns. Considering the sheer size of Wikipedia articles (more than 4 million concepts), reinterpreting original documents based on all possible concepts of Wikipedia can be prohibitively expensive. Therefore, it is essential that the techniques used for such a semantic re-interpretation should be fast.

More importantly, enriching original documents with all possible Wikipedia concepts, for example, imposes an additional overhead in the application level, since enriched-documents will be represented in the augmented concept-space that corresponds to a very high dimension. Most applications do not require documents to be represented with all possible Wikipedia concepts, since they are not equally important to the given document. Indeed, insignificant concepts tend to be noisy. Thus, there is a need to efficiently find the best k concepts in Wikipedia that match a given original document, and semantically reinterpret it based on such k concepts.

### SUMMARY

Given a keyword matrix representing the keyword collection, efficiently identifying the best-k results that match a given keyword query is not trivial. Firstly, the size of keyword matrix is huge. Secondly, the sparsity of keyword matrix limits us to apply the most well-known top-k processing methods to our problem. Thus, the goal is to develop efficient mechanisms to compute the approximate top-k keywords that are most relevant to the given document query. In particular, the SparseTopk algorithm is presented that can effectively estimate the scores of unseen objects in the presence of a user (application) provided acceptable precision rate and computes the approximate top-k results based on these expected scores.

In accordance with one embodiment, a method is provided for semantic interpretation of keywords. The method includes the steps of obtaining one or more keywords for semantic interpretation; computing top-k concepts in a knowledge database for the one or more keywords; and mapping the one or keywords into a concept space using the top-k concepts.

In accordance with another embodiment, a system is provided for performing automatic image discovery for displayed content. The system includes a topic detection module, a keyword extraction module, an image discovery module, and a controller. The topic detection module is configured to detect a topic of the content being displayed. The keyword extraction module is configured to extract query terms from the topic of the content being displayed. The image discovery module is configured to discover images based on query terms; and the controller is configured to control the topic detection module, keyword extraction module, and image discovery module.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a system diagram outlining the delivery of video and audio content to the home in accordance with one embodiment.

FIG. 2 is system diagram showing further detail of a representative set top box receiver in accordance with one embodiment.

FIG. 3 is a diagram showing a process performed at the set top box receiver in accordance with one embodiment.

FIG. 4 is a flow diagram showing the process of semantic interpretation in accordance with one embodiment.

FIG. 5 is a diagram showing how a semantic interpreter maps keywords from the keyword space to the concept space in accordance with one embodiment.

FIG. 6 is the general framework of a semantic interpreter which relies on ranked processing schemes in accordance with one embodiment.

FIG. 7 is an example of pseudo-code for computing the approximate top-k concepts in accordance with one embodiment.

FIG. 8 is an example of pseudo-code for mapping the keywords from the keyword space to the concept space.

### DETAILED DESCRIPTION

The present principles are directed to content search and more specifically semantic interpretation of keywords used for searching using a Top-k technique.

It will thus be appreciated that those skilled in the art will be able to devise various arrangements that, although not explicitly described or shown herein, embody the present invention and are included within its spirit and scope.

All examples and conditional language recited herein are intended for pedagogical purposes to aid the reader in understanding the present invention and the concepts contributed by the inventor(s) to furthering the art, and are to be construed as being without limitation to such specifically recited examples and conditions.

Moreover, all statements herein reciting principles, aspects, and embodiments of the present invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present invention as defined by such claims resides in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

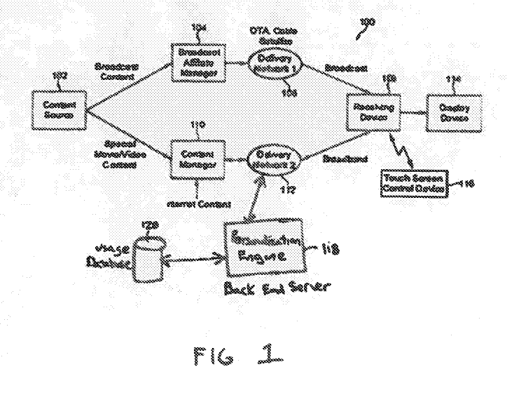

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108 in a user's home, where the content will subsequently be searched by the user. It is to be appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

A second form of content is referred to as special content. Special content may include content delivered as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

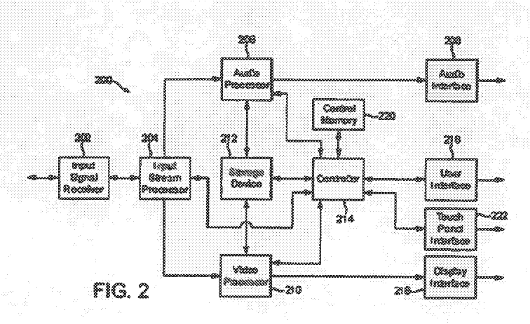

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a primary display device 114. The primary display device 114 may be a conventional 2-D type display or may alternatively be an advanced 3-D display.

The receiving device 108 may also be interfaced to a second screen such as a second screen control device, for example, a touch screen control device 116. The second screen control device 116 may be adapted to provide user control for the receiving device 108 and/or the display device 114. The second screen device 116 may also be capable of displaying video content. The video content may be graphics entries, such as user interface entries, or may be a portion of the video content that is delivered to the display device 114. The second screen control device 116 may interface to receiving device 108 using any well known signal transmission system, such as infra-red (IR) or radio frequency (RF) communications and may include standard protocols such as infra-red data association (IRDA) standard, Wi-Fi, Bluetooth and the like, or any other proprietary protocols. Operations of touch screen control device 116 will be described in further detail below.

In the example of FIG. 1, the system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 may be part of the back end server 118a. In the present example, the back end server 118 (as well as the usage database 120) is connected to the system the system 100 and accessed through the delivery network 2 (112).

Turning now to FIG. 2, a block diagram of an embodiment of a receiving device 200 is shown. Receiving device 200 may operate similar to the receiving device described in FIG. 1 and may be included as part of a gateway device, modem, set top box, or other similar communications device. The device 200 shown may also be incorporated into other systems including an audio device or a display device. In either case, several components necessary for complete operation of the system are not shown in the interest of conciseness, as they are well known to those skilled in the art.

In the device 200 shown in FIG. 2, the content is received by an input signal receiver 202. The input signal receiver 202 may be one of several known receiver circuits used for receiving, demodulating, and decoding signals provided over one of the several possible networks including over the air, cable, satellite, Ethernet, fiber and phone line networks. The desired input signal may be selected and retrieved by the input signal receiver 202 based on user input provided through a control interface 222. Control interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary, a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or control interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results in a three dimensional gird as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the gird display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM) , electronically erasable programmable ROM (EEPROM), etc.) for storing information and instruction code for controller 214. Control memory 220 may store instructions for controller 214. Control memory may also store a database of elements, such as graphic elements containing content. The database may be stored as a pattern of graphic elements. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

The user interface process of the present disclosure employs an input device that can be used to express functions, such as fast forward, rewind, etc. To allow for this, a second screen control device such as a touch panel device may be interfaced via the user interface 216 and/or control interface 222 of the receiving device 200.

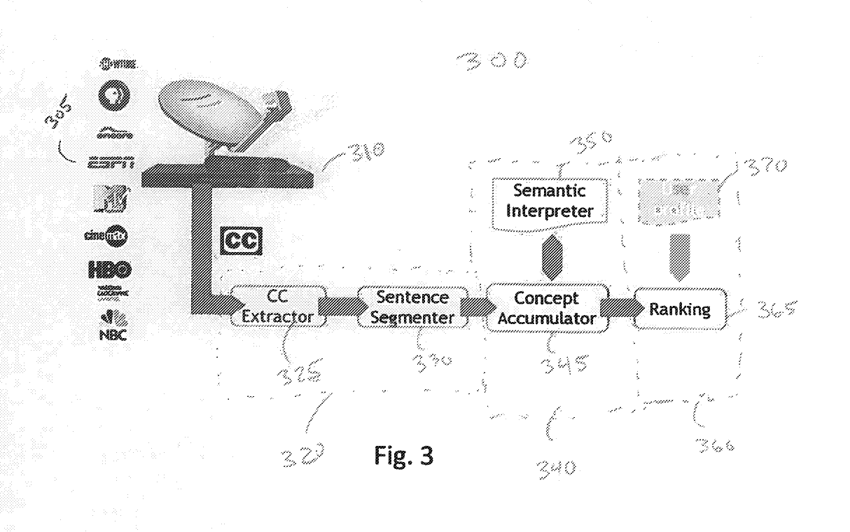

FIG. 3 depicts one possible embodiment of the process 300 involved in performing semantic interpretation in Set Top Box (STB) 310 such as receiving device 106, 200 discuss above in regard to FIGS. 1 and 2. Here STB 310 receives content 305 from a content source 102. The content 305 is then processed in three parts: 1) keyword collection 320, 2) concept collection 340, 3) concept processing 360. In the keyword collection 320, A Close Caption Extractor 325 is used to receive, capture, and otherwise extract the close captioning data provided as part of the content 305. A Sentence Segmenter 330 is then used to identify sentence structures in the close captioning data to look for candidate phrases and keywords such as the subject or object of sentences as well as whole phrases. For many sentences in closed captioning, the subject phrases are very important. As such, a dependency parser can be used to find the head of a sentence and if the head of the sentence is also a candidate phrase, the head of the sentence can be given a higher priority. The candidate keywords are then used to find relevant concepts in concept collection 340. This is also where a Semantic Interpreter 350 is used to map the candidate keywords into concepts. The concepts can then be groupe together by the concept accumulator 340. The resulting accumulated concepts can then be processed 360. This can include ranking 365 and other functionality such as creating a user profile 370.

For example, close captioning of segments can be used to create a TV watching profile for users, so that content can be personalized, thereby improving the quality of recommendations given to the user. There are many other applications of creating an accurate and informative user profile, such as being able to match advertisements or to suggest friends that have similar interests. A key problem faced by current systems for creating profiles from a user's TV watching habits is the sparsity and lack of accurate data. In order to mitigate this issue, close captioning segments corresponding to the TV program segments watched can be captured, along with other metadata such as the time of viewing and the EPG information of the program. By capturing the close captioning, it is possible to understand what the user's interests are and provides a basis to give content based recommendations. Furthermore, when the captured close captioning is mapped to concept space using the semantic interpreter, the resulting profile is more intuitive to understand, and to exploit. As an extra benefit, the amount of data needed to be stored is reduced as the entire close captioning segments are not stored. Only the top-k concepts that the close captioning segment represents are stored.

In another example, concepts mapped by the semantic interpreter can be used to segment videos, both online (for e.g. live/broadcast), and offline (for e.g. DVRed) based on close captioning data. Each segment should contain a set of concepts so that it is one coherent unit (e.g., a segment on Tiger Woods in the evening news). Once the video is segmented, the corresponding close captioning segment can be mapped to the concept space and the video annotated with the resulting top-k concepts. An application of this will be to let people share these mini clips with friends or save them to DVR or simply tag it as interesting. This is useful as the users are not interested in an entire video or the entire video might be too big to share or might have copyright issues. Modern DVRs already record the program being watched in order to provide live pause/rewind functions. This can be further augmented to trigger the segmentation and concept-mapping algorithms so that the resulting segments can be tagged and/or saved and/or shared along with brief time intervals (+/- t seconds) before and after the detected segment.

In another example, these techniques can be used to improve searches. Currently, users need to search for information using exact keywords in order to find programs of interest. While this is useful if the user knows exactly what he or she is looking for, searching exact keywords impedes discovery of newer and more exciting content that might be of interest to the user. The semantic interpreter can be used to solve this problem. The concept space can be derived from the Wikipedia as it can be deemed for practical purposes to represents the entire human knowledge. Any document represented in this space can hence be queried using the same concepts. For example, the user should be able to use high level knowledge such as “Ponzi Scheme” or “Supply Chain” and discover media that is most relevant to that concept. This discovery will be possible even if the corresponding media has no keywords that exactly match “Ponzi Scheme” or “Supply Chain”. Furthermore, by setting up standing filters, any incoming media can be mapped to the concept space and if the concepts match the standing filter, then such media can be tagged for further action by the system. When programs that match the users filter rule is broadcast the user is notified and choose to save, browse related, share or view them.

While in the example of FIG. 3, the process is performed in STB 310, it should be understood the same process can also be performed at the content source 102 or service provider 104, 110. In some instances, the parts can be split among different devices or locations as necessary or desired. Indeed, in many instances the semantic interpretation is performed at a remote server and the resulting concepts are provided back to the STB 310, content source 102, or service provider 104, 110 for further processing.

In the case of processing at the content source 102, when content is created, the corresponding close captioning or subtitle data is mapped to the concept space. The inferred concepts are then embedded into the media multiplex as a separate stream (for e.g. using the MPEG-7 standard). The advantage is that the process needs to be performed only once per media file instead of multiple times. The disadvantage is that standards need to be developed for embedding, further processing and consumption of this meta-data.

In the case of processing at the service provider 104 or 110, the processing occurs when content is transmitted via the service provider's network or in the cloud. For example, the service provider can process all incoming channels using a Semantic Interpreter and embed the metadata in a suitable fashion (MPEG-7, proprietary or using web based technologies). The service provider need not resort to standard schemes, as long as their STB can interpret and further process this metadata. The big advantage of this approach is that no elaborate standards need to be developed; also, these schemes can be used to differentiate different service providers.

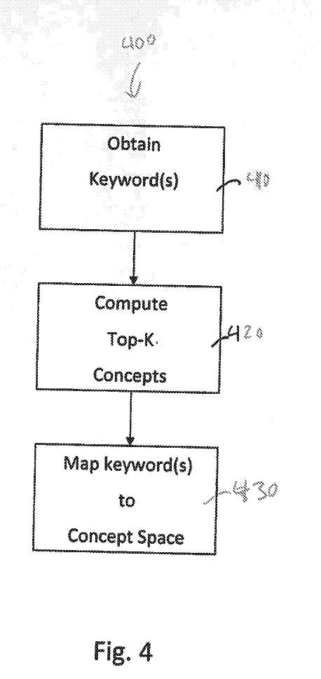

Referring now to FIG. 4, a flow diagram 400 is depicted showing one embodiment of the process involved in performing Semantic Interpretation using top K concepts. First, one or more keywords are obtained for semantic interpretation (step 410). The one or more keywords are then used to compute top-k concepts in a knowledge database (step 420). The keywords can then be mapped into a concept space using the top-k concepts (step 430).

The one or more keyword can be obtained in any number of ways. Keywords may be obtained using keyword extraction involving close caption data as described above in reference to FIG. 3. In other embodiments keywords can be extracted from data related to a piece of content such a summary, program description, abstract, synopsis, etc. In still other embodiments a user can provide search terms. In the description of the process below the keywords are provided as part of a document.

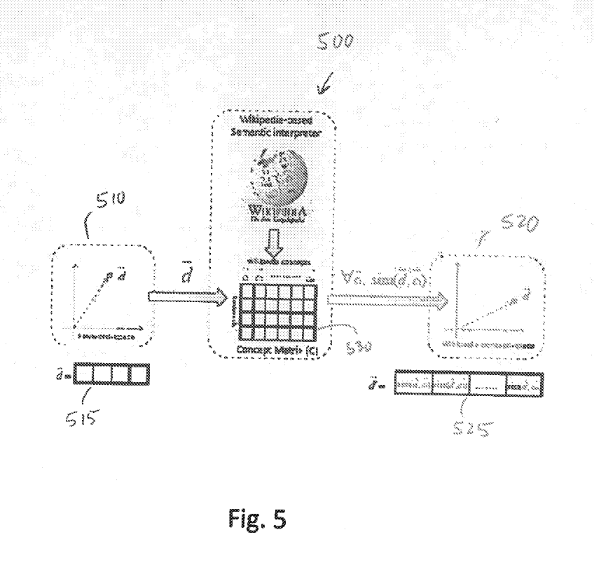

The step of computing the top-k concepts (Step 420) and mapping to a concept space (Step 430) is described below in conjunction FIGS. 5-8 with the discussion of the SparseTopk algorithm.

### Problem Definition

In this section, the problem is formally defined and the notation used to develop and describe the algorithms is introduced.

Semantic Reinterpretation with the All Possible Wikipedia Concepts

Let u be a dictionary with u distinct words. The concepts in Wikipedia, for example, are represented in the form of a u×m c-concept matrix, C (530) where m is the number of concepts that corresponds to articles of Wikipedia and u is the number of distinct keywords in the dictionary. Let C_{i,r} denote the weight of the i-th keyword tᵢ, in the r-th concept, cᵣ. Let C−,ᵣ=[w_{1,r}, w_{2,r}, . . . , w_{u,r}]^{T} be the r-th concept vector. Without loss of generality, it is assumed that each concept-vector, C−ᵣ, is normalized into a unit length.

Given a dictionary u, a document, d, is represented as a l-dimensional vector, \vec{d}=[w₁, w₂, . . . , wᵤ] (515).

Given a keyword-concept matrix, C(530), and a document vector, c I, a semantically re-interpreted (enriched) document vector with all possible Wikipedia concepts, \vec{d}=[w′₁, w′₂, . . . , w′ₘ] (525), is defined as

\vec{d}′=\vec{d}C.

By definition of matrix multiplication, the contribution of the concept cᵣ in the vector \vec{d}′ is computed as follows:

$${w}_{r}^{′} = {\sum }_{1 \leq i \leq u} {w}_{i} \times {C}_{i , r} = {\sum }_{{∀}_{{w}_{i} \neq 0}} {w}_{i} \times {C}_{i , r} .$$

Semantic Reinterpretation with the Top-k Wikipedia Concepts

As mentioned in the introduction, computing \vec{d}′ all possible Wikipedia concepts may be prohibitively expensive. Thus, the goal is to reinterpret a document with the best k concepts in Wikipedia that are relevant to it.

Given a re-interpreted document \vec{d}′=[w′₁; w′₂, . . . , w′ₘ], let Sₖ be a set of k concepts, such that the following holds:

∀_{c}_{ᵣ}∈Sₖ, cₚ∉Sₖ w′ᵣ≧w′ₚ.

In other words, Sₖ contains k concepts whose contributions to \vec{d}′ are greater than or equal to the others. Then, a semantic re-interpretation of \vec{d} based on the top-k concepts in Wikipedia that match it is defined as \vec{d}=[w′₁, w′₂, . . , w′ₘ] where

$$if {c}_{r} ∈ {S}_{k} , \\ {w}_{r}^{′} = {\sum }_{1 \leq i \leq u} {w}_{i} \times {C}_{i , r} = {\sum }_{∀ {w}_{i} \neq 0} {w}_{i} \times {C}_{i , r}$$

$$otherwise , {w}_{r}^{′} = 0.$$

Problem Definition: Semantic Reinterpretation with the Approximate Top-k Wikipedia Concepts

Exactly computing the best k concepts that are relevant to a given document often requires scanning an entire keyword-concept matrix, which is very expensive. Thus, in order to achieve further efficiency gains, Sₖ is relaxed as follows: given a document \vec{d}, let S_{k,α} be a set of k concepts such that at least αk answers in S_{k,α} belong to Sₖ, where 0≦α≦1. Then, the objective is defined as follows:

Problem 1 (Semantic re-interpretation with S_{k,α}) Given a keyword-concept matrix, C, a document vector, \vec{d}, and the corresponding approximate best k concepts, S_{k,α}, a semantic re-interpretation of \vec{d} based on the approximate top-k concepts in Wikipedia that match it is defined as \vec{d}=[w′₁, w′₂, . . . , w′ₘ] where

$$if {c}_{r} ∈ {S}_{k , α} , \\ {w}_{r}^{′} \approx {\sum }_{1 \leq i \leq u} {w}_{i} \times {C}_{i , r} = {\sum }_{∀ {w}_{i} \neq 0} {w}_{i} \times {C}_{i , r} \\ otherwise , {w}_{r}^{′} = 0.$$

In other words, the original document, d, is approximately mapped from the word-space 510 into the concept-space 520 which consists of the approximate k concepts in Wikipedia that best match a document d. Thus, the key challenge to this problem is how to efficiently identify such approximate top-k concepts, S_{k,α}. To address this problem, a novel ranked processing algorithm is presented to efficiently compute S_{k,α} for a given document.

### Naive Solutions to Sₖ

In this section, naive schemes (i.e. impractical solutions) are first described for exactly computing the top-k concepts, Sₖ, of a given document.

### Scanning the Entire Data

One obvious solution to this problem is to scan the entire u×m. keyword-concept matrix, C 530, multiply the document vector, cl, with each concept vector, C=r, sort the resulting scores, w′ᵣ (where 1≦r≦m), in descending order, and choose only the k -best solutions. A more promising solution to this problem is to leverage an inverted index, commonly used in IR systems, which enables to scan only those entries whose corresponding values in the keyword-concept matrix are greater than 0. Both schemes would be quite expensive, because they waste most of resources in processing unpromising data that will not belong to the best k results.

### Threshold-Based Ranked Processing Scheme

There have been a large number of proposals for ranked or top-k processing. As stated above, the threshold-based algorithms, such as Threshold Algorithm (TA), Fagin's Algorithm (FA), and No Repeating Algorithm (NRA) are the most well-known methods. These algorithms assume that given sorted-lists, each object has a single score in each list and an aggregation function, which combines independent object's scores in each list, is monotone such as min, max, (weight) sum and product. These monotone scoring functions guarantee that a candidate dominating the other one in its sub-scores will have a combined score better than the other one, which enables early stopping during the top-k computation, to avoid scanning all the lists. Generally, TA (and FA) algorithms require two access methods: random-access and sorted-access. However, supporting random-access to a high-dimensional data, such as document-term matrix, would be prohibitively expensive. Therefore, NRA is employed as a base framework, since it requires only a sorted-access method, and thus is suitable for high-dimensional data, such as a concept matrix C.

### Sorted Inverted Lists for the Concept Matrix

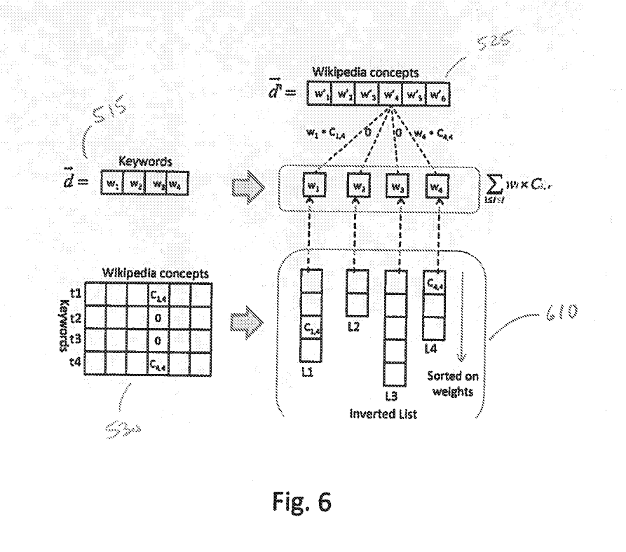

To support sorted accesses to auxm keyword-concept matrix, C 530, an inverted index 610 that contains u lists is created (FIG. 6). For each keyword tᵢ, the corresponding list T_{i,r} contains a set of [symbol] cᵣ, C_{i,r} [symbol] s, where is the weight of the keyword, lᵢ, in Wikipedia concept cᵣ. As shown in FIG. 6, each inverted list maintains only concepts whose weights are greater than 0. This inverted list is created in decreasing value on weights to support sorted accesses.

### NRA-Based Scheme for Computing Sₖ

From the definition of given above, it is clear that the score function is monotone in the u independent lists since it is defined as a weight sum. Given a document \vec{d}=[w₁, w₂, . . . , wᵤ], NRA visits the input lists in a round-robin manner and updates a threshold vector t\vec{h}=[τ₁, τ₂, . . , τᵤ] where τᵢ is the last weight read on the list Lᵢ. In other words, a threshold vector consists of the upper bounds on the weights of unseen instances in input lists. After reading an instance [symbol] cᵣ, C_{i,r} [symbol] in the list, Lᵢ, the possible worst score of the r-th position in the semantically reinterpreted document vector, \vec{d}′=[w′₁, w′₂, . . , w′ᵣ, . . . , w′ₘ], is computed as

$${w}_{r , wst}^{′} = {\sum }_{h ∈ {KN}_{r}} {w}_{h} \times {C}_{h , r} ,$$

where K Nᵣ is a set of positions in the concept-vector, C−,ᵣ, whose corresponding weights have been read before by the algorithm. On the other hand, the possible best score of r-th position in \vec{d}′ is computed as follows:

$${w}_{r , bst}^{′} = {\sum }_{h ∈ {KN}_{r}} {w}_{h} \times {C}_{h , r} + {\sum }_{j ∉ {KN}_{r}} {w}_{j} \times {μ}_{j} .$$

In summary, the possible worst score is computed based on the assumption that the unseen entries of the concept-vector will be 0, while the possible best score assumes that all unseen entries in the concept-vector will be encountered after the last scan position of each list. NRA maintains a cut off score, mink, equals to the lowest score in the current top-k candidates. NRA would stop the computation when a cut off score, mink, is greater than (or equal to) the highest best-score of concepts not belonging to the current top-k candidates. Although this stopping condition always guarantees to produce the correct top-k results (i.e., Sₖ in our case), such stopping condition is overly pessimistic, assuming that all unknown values of each concept vector would be read after the current scan position of each list. This, however, is not the case especially for the sparse keyword-concept matrix where unknown values of each concept vector are expected to be 0 with a very high probability. Therefore, NRA may end up scanning the entire lists, which would be quite expensive.

Efficiently Interpreting a Document with Wikipedia Concepts

In this section, the algorithm is described for the efficient semantic interpreter using Wikipedia. The proposed algorithm consists of two phases: (1) computing the approximate top-k concepts, ^{S}A of a given document and (2) mapping an original document into the concept-space using S_{k,α}.

### Phase 1: Identifying the Approximate Top-k Concept, S_{k,α}

As described above, the threshold-based algorithms are based on the assumption that given sorted-lists, each object has a single score in each list. The possible scores of unseen objects in NRA algorithm are computed based on this assumption. This assumption, however, does not hold for the sparse keyword-concept matrix where most of entries are 0. Thus, in this subsection, first a method is described to estimate the scores of unseen objects with the sparse keyword-concept matrix, and then present a method to obtain the approximate top-k concepts of a given document leveraging the expected scores.

### Estimating the Bounds on the Number of Input Lists

Since the assumption that each object has a single score in each input list is not valid for a sparse keyword-concept matrix, in this subsection the aim is to correctly estimate a bound on the number of input lists where each object is expected to be found during the computation. A histogram is usually used to approximate data distributions (i.e., probability density function). Many existing approximate top-k processing algorithms maintain histograms for input lists and estimate the scores of unknown objects by convoluting histograms. Generally, approximate methods are more efficient than exact schemes. Nevertheless, considering that there are a huge number of lists for the keyword-concept matrix, maintaining such histograms and convoluting them in run-time for computing possible aggregated scores is not a viable solution. Thus, in order to achieve further efficiency, the data distribution of each inverted list is simplified by relying on the binomial distribution: i.e., the case in which an inverted list contains a given concept or the other one in which it does not. Such simplified data distribution does not cause a significant reduction in the quality of the top-k results, due to the extreme sparsity of the concept matrix.

Given a keyword lᵢ and a keyword-concept matrix C, the length of the corresponding sorted list, Lᵢ, is defined as

|Lᵢ|=|{C_{i,r}|C_{i,r}>0 where 1≦r≦m}|.

Given a u×m keyword-concept matrix, C, we formulate the probability that an instance [symbol] (cᵣ, C_{i,r} [symbol] is in Lᵢ as

$$\frac{\vert {L}_{i} \vert}{m} .$$

Generally, the threshold-based algorithms sequentially scan the each sorted list. One can assume that the algorithm sequentially scans the first fᵢ instances from the sorted list Lᵢ, and the instance [symbol] cᵣ, C_{i,r} [symbol] was not seen during the scans. Then, one can compute the probability, [symbol] that an instance [symbol] cᵣ, C_{i,r} [symbol] will be found in the unscanned parts of the list Lᵢ (i.e., the remaining (|Lᵢ|−fᵢ) instances) as follows:

$${P}_{〈 {C}_{i , r} , {f}_{i} 〉} = \frac{\vert {L}_{i} \vert - {f}_{i}}{m - {f}_{i}} .$$

Note that [symbol] will be 1 under the assumption that each object has a single score in each input list (i.e., |Lᵢ⊕=m). However, the keyword-concept matrix is extremely sparse, and thus, in most cases, [symbol] is close to 0.

Given a document, d, and a corresponding u-dimensional vector, \vec{d}=[w₁, w₂, . . . , wᵤ]. Furthermore, given \vec{d}, let L be a set of sorted lists such that:

L−{Lᵢ|wᵢ>0 where 1≦i≦u}.

In other words, L is a set of sorted lists whose corresponding words appear in a given document d. Other lists not in L do not contribute to the computation of the semantically reinterpreted vector, \vec{d}′, because their corresponding weights in the original vector \vec{d} equal to 0 (FIG. 2).

Further, it can be assumed that the occurrences of words in a document are independent of each other. The word-independence assumption has long been used by many applications due to its simplicity. Let P_{found}_{—}_{exact(L, c}_{ᵣ}_{,n)} be the probability that the concept cᵣ, which was not yet seen in any list so far, will be found in exactly n lists in L afterward. Then, the probability can be computed as follows:

$${P}_{found \_ exact ( ℒ , {c}_{r} , n )} = ( \begin{matrix}\vert ℒ \vert \\ n\end{matrix} ) {P}_{〈 {c}_{r} , avg 〉}^{n} \times {( 1 - {P}_{〈 {c}_{r} , avg 〉} )}^{\vert ℒ \vert - n} . \\ where , \\ {P}_{〈 {c}_{r} , avg 〉} = \frac{1}{\vert ℒ \vert} {\sum }_{{L}_{i} ∈ ℒ} {P}_{〈 {C}_{i , r} , {f}_{i} 〉} .$$

Furthermore, one can compute the P_{found}_{—}_{upto(L,c}_{ᵣ}_{,n}), the probability that a fully unseen concept cᵣ will be found in up to n lists in L during the computation as follows:

$${P}_{found \_ upto ( ℒ , {c}_{r} , n )} = {\sum }_{0 \leq q \leq n} {P}_{found \_ exact ( ℒ , {c}_{r} , q )} .$$

Note that P_{found}_{—}_{upto(L,c}_{ᵣ}_{,|L}) always equals to 1.

As described earlier, the objective is to find the approximate top-k concepts, S_{k,α}, satisfying that at least ak answers in S_{k,α} belong to the exact top-k results, Sₖ. Given an application (or user) provided acceptable precision rate a, in order to compute the bound, bᵣ, on the number of lists where a fully unavailable concept, cᵣ, will be found, the value chosen is the smallest value br satisfying

P_{found}_{—}_{upto(L,C}_{ᵣ}_{,b}_{ᵣ},)≧α.

In summary, bᵣ is the smallest value satisfying the probability of an unseen concept cᵣ being less than bᵣ input lists is higher than an acceptable precision rate, α.

### Computing Expected Score for Fully or Partially Unseen Object

Once one estimates the number of lists where any fully unseen object will be found, one can compute the expected scores of fully (or partially) unseen objects.

Given a current threshold vector t\vec{h}=[τ₁, τ², . . . , τᵤ] and an original document vector \vec{d}=[w₁, w₂, . . . , wᵤ], we define W as follows:

W={wᵢ×τᵢ|1≦i≦u}.

Then, the expected score of the fully unseen concept cᵣ is bounded by

$${w}_{r , exp}^{′} \leq {\sum }_{1 \leq h \leq {b}_{r}} {W}_{h} ,$$

where Wₕ is the h-th largest value in W.

Each list in an inverted index is sorted on weights rather than concept IDs, which results in a partially available (seen) concept-vector of a given concept, cᵣ, during the top-k computation. Thus, we also need to estimate the expected scores of partially seen objects. Let crbe a partially seen concept. Furthermore, let K Nᵣ be a set of positions in the concept-vector, C−.ᵣ, whose weights have been seen before by the algorithm. Then, the expected score of partially seen concept cᵣ is defined as follows:

$$If \vert {KN}_{r} \vert \geq {b}_{r} , then$$

$${w}_{r , exp}^{′} = {\sum }_{h ∈ {KN}_{r}} {w}_{h} \times {C}_{h , r} . \\ Otherwise , \\ {w}_{r , exp}^{′} = {\sum }_{h ∈ {KN}_{r}} {w}_{h} \times {C}_{h , r} + {\sum }_{\vert {KN}_{r} \vert + 1 \leq h \leq {b}_{r}} {W}_{h} .$$

Note that the expected score of any fully or partially seen concept, cᵣ, will equal to the possible best score described above, when the bound, bᵣ, on the number of input lists where cᵣ will be found is same with L. However, the sparsity of the keyword-concept matrix guarantees that the expected scores are always less than the possible best scores.

### The Algorithm

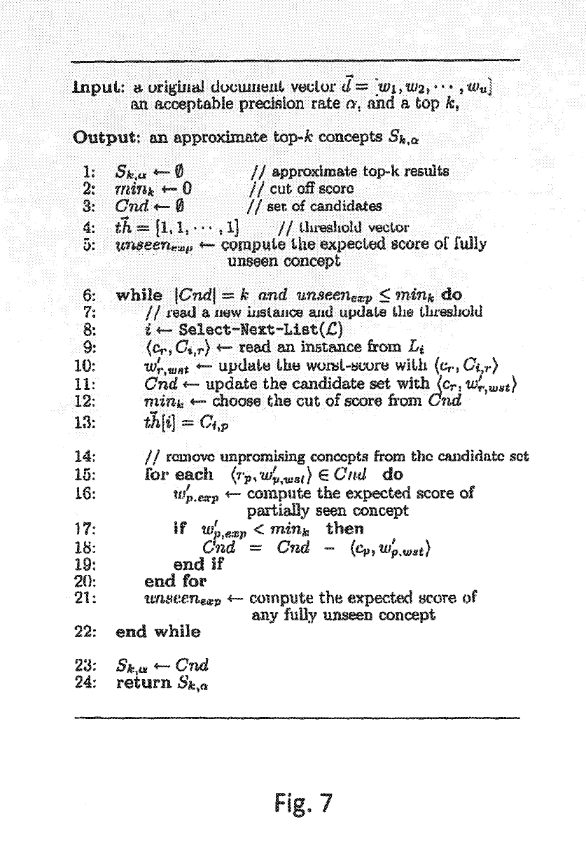

FIG.7 describes the pseudo-code for the proposed algorithm to efficiently compute the approximate top-k concepts, S_{k,α}, of a given document. The algorithm first initializes the set of the approximate top-k, S_{k,α}, the cut off score, minₖ, and the set of candidates, Cnd. The threshold vector, t\vec{h}, is initially set to [1, 1, . . . , 1. Initially, the expected score of any fully unseen concept is computed, as described in above (line 1-5).

Generally, the threshold algorithms visit or access input lists in a round-robin manner. In cases where the input lists have various lengths, however, this scheme can be inefficient, as resources are wasted for processing unpromising objects whose corresponding scores are relatively low, but are read early because they belong to short lists. To resolve this problem, the input lists are visited in a way to minimize the expected score of a fully unavailable concept. Intuitively, this enables the algorithm to stop the computation earlier by providing a higher cut off score, mink.

Given an original document vector, \vec{d}=[w₁, w₂, . . . , wᵤ], and a current threshold vector, t\vec{h}=τ₁, τ₂, . . , τᵤ], to decide which input list will be read next time by the algorithm, a list Lᵢ (line 8) is desired such that:

∀_{L} _{ₕ}_{∈L-{L}_{ᵢ}_{}}wₕ×τₕ<wᵢ×τᵢ.

The list satisfying the above condition guarantees to minimize the expected score of any unavailable concept, and thus provides the early stopping condition to the algorithm.

For a newly seen instance [symbol] cᵣ, C_{i,r} [symbol] in the list Lᵢ, we compute the corresponding worst score, w′_{r,wst}, is computed and the candidate list is updated with [symbol] cᵣ, w′_{r,ust} [symbol] (line 9-11). The cut off score, minₖ, is selected such that minₖ equals to the k -th highest value of the worst scores in the current candidate set, Cnd (line 12). Then, the threshold vector is updated (line 13).

Between line 15 and 20, unpromising concepts are removed from the candidate set, which will not be in the top-k results with a high probability. For each concept, cₚ, in the current candidate set, the corresponding expected score, w′_{p,exp} is computed, as described in above. Note that each concept in the current candidate set corresponds to a partially seen concept. If the expected score, w′_{p,exp}, of the partially seen concept, cₚ, is less than the cut off score, the pair, [symbol] cₚ, w′_{p,uist} [symbol] is removed from the current candidate set, since this concept is not expected to be in the final top-k results with a high probability (line 18). In line 21, the expected score of any fully unseen concept is computed. The top-k computation stops only when the current candidate set contains k elements and the expected scores of fully unseen concepts are likely to be less than the cut off score (line 7).

Phase 2: Mapping a Document from the Keyword-Space into the Concept-Space

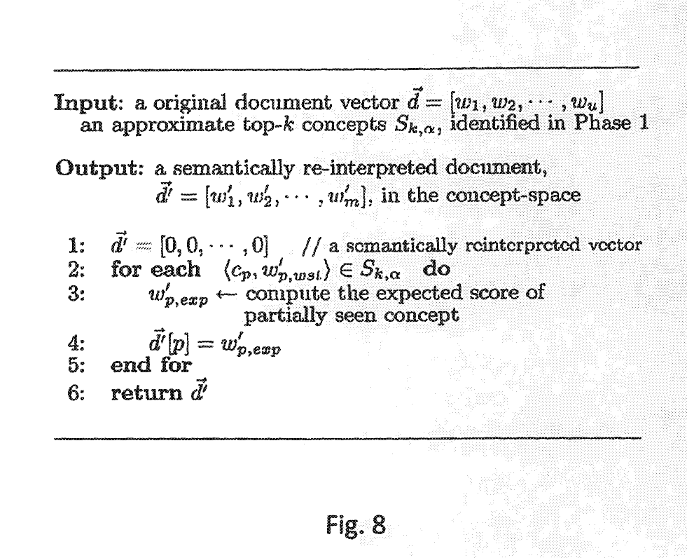

Once the approximate top-k concepts of a given document are identified, the next step is to map an original document from the keyword-space into the concept-space. FIG. 8 describes the pseudo-code for mapping an original document from the keyword-space into the concept-space using S_{k,α}.

Initially, a semantically reinterpreted vector, \vec{d}′, is set to [0, 0, . . . , 0] (line 1). Since the algorithm in FIG. 4 stops before scanning full input lists, the concept-vectors of the concepts in S_{k,α} are partially available. Therefore, for each concept in S_{k,α} it is needed to estimate the expected scores with the partially seen concept-vectors, as explained above (line 3). Then, the corresponding entries in the semantically reinterpreted vector, \vec{d}′, are updated with the estimated scores (line 4). Finally, the algorithm returns a semantically re-interpreted document vector, \vec{d} (line 6). A novel semantic interpreter is described for efficiently enriching original documents based on concepts of the Wikipedia. The proposed approach enables to efficiently identify the most significant k -concepts in Wikipedia for a given document and leverage these concepts to semantically enrich an original document by mapping it from keyword-space to the concept-space. //Experimental results show that the proposed technique significantly improves efficiency of semantic reinterpretation without causing significant reduction in precision.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for performing semantic interpretation for keywords, the method comprising:
obtaining one or more keywords for semantic interpretation;
computing top-k concepts in a knowledge database for the one or more keywords; and
mapping the one or keywords into a concept space using the top-k concepts.

2. The method of claim 1, wherein the step of computing top-k concepts comprises the steps of:
estimating the bounds on the number of input lines; and
computing an expected score for a fully or partially unseen object.

3. The method of claim 1, wherein the step of obtaining one or more keywords for semantic interpretation comprises extracting keywords from close captioning data included with content.

4. The method of claim 1, further comprising processing concepts resulting from the mapping of the one or more keywords into the concept space.

5. The method of claim 4, wherein the processing comprises ranking the concepts

6. The method of claim 4, wherein the processing comprises creating a user profile based on the resulting concepts.

7. The method of claim 4, wherein the processing comprises creating a segmenting content based on the resulting concepts.

8. The method of claim 4, wherein the processing comprises filtering based on the resulting concepts.

9. The method of claim 4, wherein the processing comprises searching based on the resulting concepts.

10. A system for performing semantic interpretation for keywords, the system comprising:
keyword collection;
concept collection; and
concept processing.

11. The system of claim 10, wherein keyword collection comprises:
a close caption extractor; and
a sentence segmenter;

12. The system of claim 10, wherein concept collection comprises:
a semantic interpreter; and
a concept accumulator.

13. The system of claim 10, wherein concept processing comprises:
ranking; and
a user profile

14. A computer program product comprising a computer useable medium having a computer readable program, wherein the computer readable program when executed on a computer causes the computer to perform method steps including:
obtaining one or more keywords for semantic interpretation;
computing top-k concepts in a knowledge database for the one or more keywords; and
mapping the one or keywords into a concept space using the top-k concepts.
